(19) United States
(12) Patent Application Publication
(10) Pub. No.: US 2024/0116400 A1
(43) Pub. Date: Apr. 11, 2024

(54) VEHICLE

(71) Applicant: TOYOTA JODOSHA KABUSHIKI KAISHA, Toyota-shi Aichi-ken (JP)

(72) Inventor: Mitsuyoshi OHNO, Miyoshi-shi Aichi-ken (JP)

(73) Assignee: TOYOTA JODOSHA KABUSHIKI KAISHA, Toyota-shi Aichi-ken (JP)

(21) Appl. No.: 18/367,675

(22) Filed: Sep. 13, 2023

(30) Foreign Application Priority Data
Oct. 11, 2022 (JP) 2022-163450

(51) Int. Cl. B60N 2/01; B60N 2/06

(52) U.S. Cl. CPC B60N 2/01; B60N 2/06; B60N 2002/022

(57) ABSTRACT

A vehicle, includes: a vehicle body, and a side door opening portion opened and closed by a side door, formed at a side of the vehicle body; a seatbelt device having a seatbelt, a tongue plate, and a buckle; and a seat at which the seatbelt device is installed, the buckle being fixed at one side in a transverse direction of the seat, the seat being attached to a floor of a cabin so as to be rotatable about a rotation axis extending in a vehicle vertical direction, and the seat being disposed at a position at which, in a state in which the seat is oriented toward a vehicle rear side, the one side in the transverse direction of the seat is disposed at the side in the transverse direction of the vehicle body, and the buckle and the side door opening portion do not overlap in a vehicle transverse direction.

### CROSS-REFERENCE TO RELATED APPLICATION

This application is based on and claims priority under 35 USC 119 from Japanese Patent Application No. 2022-163450 filed on Oct. 11, 2022.

### BACKGROUND

### Technical Field

The present disclosure relates to a vehicle.

### Related Art

Japanese Patent Application Laid-Open (JP-A) No. 2017-039400 discloses a vehicle in which, due to a seat such as the driver's seat or the like being rotated as seen in a plan view of the vehicle, the seat such as the driver's seat or the like can be switched between a state of being oriented toward the front side of the vehicle and a state of being oriented toward the rear side of the vehicle.

In a case in which a seat, which is equipped with a seatbelt device having a seatbelt applied to a seated passenger, a tongue plate through which the seatbelt is inserted, and a buckle with which the tongue plate is engaged, is rotated as seen in a plan view of the vehicle, it can be assumed that the buckle will be disposed at vicinity of a side door of the vehicle.

In this case, when the vehicle is involved in a side collision, it is supposed that the side door will be displaced toward an inner side of the vehicle cabin, and a clearance between the buckle and the side door will decrease. As a result, operation of the buckle becoming difficult, e.g., pushing of a button of the buckle becoming difficult, can be expected.

### SUMMARY

In view of the above-described circumstances, the present disclosure provides a vehicle in which operation of a buckle becoming difficult at the time of a side collision can be suppressed.

A vehicle of a first aspect includes: a vehicle body having a cabin in which a passenger rides, and a side door opening portion, which is opened and closed by a side door, formed at a side in a transverse direction of the vehicle body; a seatbelt device having a seatbelt formed in a belt-shape, a tongue plate through which the seatbelt is inserted, and a buckle with which the tongue plate engages; and a seat at which the seatbelt device is installed, the buckle being fixed at one side in a transverse direction of the seat, the seat being attached to a floor of the cabin so as to be rotatable about a rotation axis that extends in a vehicle vertical direction, and, in a state in which the seat is oriented toward a vehicle rear side, the seat being disposed at a position at which the one side in the transverse direction of the seat is disposed at the side in the transverse direction of the vehicle body, and the buckle and the side door opening portion do not overlap in the vehicle transverse direction.

In accordance with the vehicle of the first aspect, due to the seat, which is attached to the floor of the cabin, being rotatable around the rotation axis extending in the vehicle vertical direction, the seat can be oriented toward the vehicle rear side. A passenger seated in this seat engages the tongue plate with the buckle, the seatbelt is applied to the passenger seated in the seat. In the state in which the seat is oriented toward the vehicle rear side, one side in the transverse direction of the seat is disposed at the side in the transverse direction of the vehicle body (i.e., at the side door). Namely, the buckle that is fixed to the seat is disposed at the side in the transverse direction of the vehicle body. Further, in the state in which the seat is oriented toward the vehicle rear side, the seat is disposed at a position at which the buckle and the side door opening portion do not overlap in the vehicle transverse direction. Due thereto, even if the side door is displaced toward a cabin side at the time of a side collision, the clearance between the side door and the buckle is ensured. As a result, operation of the buckle becoming difficult at the time of a side collision can be suppressed.

In a vehicle of a second aspect, in the vehicle of the first aspect, the seat is attached to the floor of the cabin in a state in which movement of the seat in a vehicle front-rear direction with respect to the floor of the cabin is prohibited.

In accordance with the vehicle of the second aspect, the buckle and the side door opening portion is prevented from being overlapping in the vehicle transverse direction in accordance with the movement of the seat in the vehicle front-rear direction.

In a vehicle of a third aspect, the vehicle of the first aspect further includes a front-rear slide supporting portion that supports the seat such that the seat is movable in a vehicle front-rear direction; a front-rear sliding actuator that, by operation, moves the seat in the vehicle front-rear direction; and a seat control unit configured to control the front-rear sliding actuator. The seat control unit includes a memory and a processor coupled to the memory, the processor is configured to, when the processor detects that the seat is oriented toward the vehicle rear side, operate the front-rear sliding actuator such that the seat is moved to a position at which the buckle and the side door opening portion do not overlap in the vehicle transverse direction.

In accordance with the vehicle of the third aspect, when it is detected by the processor that the seat is oriented toward the vehicle rear side, the processor is configured to operate the front-rear sliding actuator, and the seat is moved to a position at which the buckle and the side door opening portion do not overlap in the vehicle transverse direction. Due thereto, the buckle and the side door opening portion overlapping in the vehicle transverse direction can be prevented.

In a vehicle of a fourth aspect, the vehicle of the first aspect further includes a front-rear slide supporting portion that supports the seat such that the seat is movable in a vehicle front-rear direction. In a state in which the seat is oriented toward the vehicle rear side, a range of movement of the seat that is permitted by the front-rear slide supporting portion is limited to a range within which the buckle and the side door opening portion do not overlap in the vehicle transverse direction.

In accordance with the vehicle of the fourth aspect, in the state in which the seat is oriented toward the vehicle rear side, the range of movement of the seat, which is permitted by the front-rear slide supporting portion, is limited to a range within which the buckle and the side door opening portion do not overlap in the vehicle transverse direction. Due thereto, the buckle and the side door opening portion overlapping in the vehicle transverse direction can be prevented.

In a vehicle of a fifth aspect, the vehicle of the first aspect further includes a front-rear slide supporting portion that supports the seat such that the seat is movable in a vehicle front-rear direction. In a state in which the seat is oriented toward a vehicle front side, the seat is movable by the front-rear slide supporting portion, and in a state in which the seat is oriented toward the vehicle rear side, the seat is not movable by the front-rear slide supporting portion.

In accordance with the vehicle of the fifth aspect, in the state in which the seat is oriented toward the vehicle front side, the seat is movable by the front-rear slide supporting portion. On the other hand, in the state in which the seat is oriented toward the vehicle rear side, the seat is not movable by the front-rear slide supporting portion. Due thereto, the buckle and the side door opening portion is prevented form overlapping in the vehicle transverse direction, which overlapping may be happened in accordance with movement of the seat in the vehicle front-rear direction.

In a vehicle of a sixth aspect, in the vehicle of the first aspect, in a state in which the seat is oriented toward the vehicle rear side, the seat is disposed at a position at which the buckle and a vehicle body frame portion, which structures a frame at a side in a transverse direction of the vehicle body, overlap in the vehicle transverse direction.

In accordance with the vehicle of the sixth aspect, in the state in which the seat is oriented toward the vehicle rear side, the seat is disposed at a position at which the buckle and the vehicle body frame portion overlap in the vehicle transverse direction. The amount of deformation of the vehicle body frame portion toward the cabin side is small at the time of a side collision. Due thereto, the clearance between the frame portion and the buckle at the time of a side collision is ensured, and operation of the buckle becoming difficult at the time of a side collision can be suppressed.

A vehicle of a seventh aspect includes: a vehicle body having a cabin in which a passenger rides, and a side door opening portions, which is opened and closed by a side door, formed at a side in a transverse direction of the vehicle; a seatbelt device having a seatbelt formed in a belt-shape, a tongue plate through which the seatbelt is inserted, and a buckle with which the tongue plate engages; and a seat at which the seatbelt device is installed, the buckle being fixed at one side in a transverse direction of the seat, the seat being attached to a floor of the cabin so as to be rotatable about a rotation axis that extends in a vehicle vertical direction, and the seat being disposed at a position at which, in a state in which the seat is oriented toward a vehicle rear side, the one side in the transverse direction of the seat is disposed at the side in the transverse direction of the vehicle body, and the buckle and the side door opening portion do not overlap in a vehicle transverse direction; and a traveling control unit configured to control traveling of the vehicle. The traveling control unit includes a memory and a processor coupled to the memory and, in a state in which the seat is oriented toward the vehicle rear side, in a case in which the processor detects that the seat is disposed at a position at which the buckle and the side door opening portion overlap in the vehicle transverse direction, the processor is configured to carry out at least one of outputting a warning signal, limiting a traveling speed of the vehicle, and limiting acceleration of the vehicle.

In accordance with the vehicle of the seventh aspect, due to the seat, which is attached to the floor of the cabin, being rotatable around the rotation axis that extends in the vehicle vertical direction, the seat can be oriented toward the vehicle rear side. Further, due to the passenger seated in this seat engaging the tongue plate with the buckle, the seatbelt is applied to the passenger seated in the seat. In the state in which the seat is oriented toward the vehicle rear side, the one side in a transverse direction of the seat is disposed at the side in the transverse direction of the vehicle body (i.e., at the side door). Namely, the buckle that is fixed to the seat is disposed at the side in the transverse direction of the vehicle body. Further, in the state in which the seat is oriented toward the vehicle rear side, the seat can be disposed at a position at which the buckle and the side door opening portion do not overlap in the vehicle transverse direction. In the state in which the seat is oriented toward the vehicle rear side, when the processor detects that the seat is disposed at a position at which the buckle and the side door opening portion overlap in the vehicle transverse direction, the processor carries out at least one of outputting of a warning signal, limiting of the traveling speed of the vehicle, and limiting of the acceleration of the vehicle. Due thereto, the passenger can be urged to move the seat to a position at which the buckle and the side door opening portion do not overlap in the vehicle transverse direction.

In a vehicle of an eighth aspect, in the vehicle of the seventh aspect, in a case in which the vehicle is located on a road on which only autonomous vehicles can travel, or in a case in which a speed limit of a road on which the vehicle is located is less than or equal to a prescribed speed, the processor terminates control for the at least one of outputting the warning signal, limiting the traveling speed of the vehicle, and limiting the acceleration of the vehicle.

In accordance with the vehicle of the eighth aspect, in a case in which the vehicle is located on a road on which only autonomous vehicles can travel, or in a case in which the speed limit of the road on which the vehicle is located is less than or equal to a prescribed speed, the processor terminates the above-described control. Namely, in a situation in which it is anticipated that the vehicle is not involved in a collision or that there will be a small amount of displacement of the side door toward the cabin side even if the vehicle is involved in a side collision, the processor terminates the above-described control. Due thereto, the seat being disposed at a position at which the buckle and the side door opening portion overlap in the vehicle transverse direction can be permitted. Further, even if the vehicle is involved in a side collision in this situation, the clearance between the side door and the buckle is ensured, and operation of the buckle becoming difficult at the time of a side collision can be suppressed.

A vehicle of a ninth aspect includes: a vehicle body having a cabin in which a passenger rides, and a side door opening portion, which is opened and closed by a side door, formed at a side in a transverse direction of the vehicle body; a seatbelt device having a seatbelt formed in a belt-shape, a tongue plate through which the seatbelt is inserted, and a buckle with which the tongue plate engages; a seat at which the seatbelt device is installed, the buckle being fixed at one side in a transverse direction of the seat, the seat being attached to a floor of the cabin so as to be rotatable around a rotation axis that extends in a vehicle vertical direction; a left-right slide supporting portion that supports the seat such that the seat is movable in a vehicle transverse direction; a left-right sliding actuator that, by operation, moves the seat in the vehicle transverse direction; and a seat control unit configured to control the left-right sliding actuator. The seat control unit includes a memory and a processor coupled to the memory and, in a case in which the processor detects that an interval between the buckle and the side door is less than a prescribed interval, the processor is configured to operate the left-right sliding actuator such that the seat is moved to a position at which the interval between the buckle and the side door is greater than or equal to the prescribed interval.

In accordance with the vehicle of the ninth aspect, due to the passenger who is seated in the seat engaging the tongue plate with the buckle, the seatbelt is applied to the passenger seated in the vehicle seat. Further, when the left-right sliding actuator is operated, the seat is moved in the vehicle transverse direction. When the processor detects that the interval between the buckle and the side door is less than a prescribed interval, the processor is configured to operate the left-right sliding actuator such that the seat is moved to a position at which the interval between the buckle and the side door is greater than or equal to the prescribed interval. Due thereto, even if the buckle and the side door overlap in the vehicle transverse direction, the clearance between the buckle and the side door is prevented from becoming less than the prescribed interval. As a result, even if the vehicle is involved in a side collision, the clearance between the side door and the buckle is ensured, and operation of the buckle becoming difficult at the time of a side collision can be suppressed.

In the vehicle relating to the present disclosure, operation of the buckle becoming difficult at the time of a side collision can be suppressed.

### BRIEF DESCRIPTION OF THE DRAWINGS

FIG. 1 is a plan view schematically illustrating a vehicle of a first embodiment, and illustrates a state in which a seat at a front right side and a seat at a front left side are oriented forward;

FIG. 2 is a plan view schematically illustrating the vehicle of the first embodiment, and illustrates a state in which the seat at the front right side and the seat at the front left side are oriented rearward;

FIG. 3 is a side view of the vehicle illustrating door opening portions;

FIG. 4 is a cross-sectional view schematically illustrating the door opening portions and side doors that are cut along line 4-4 shown in FIG. 3;

FIG. 5 is a plan view schematically illustrating a vehicle of a second embodiment, and illustrates a state in which the seat at the front right side is oriented forward and the seat at the front left side is oriented rearward;

FIG. 6 is a plan view schematically illustrating the vehicle of the second embodiment, and illustrates a state in which the seat at the front right side has moved forward from the position illustrated in FIG. 5;

FIG. 7 is a block diagram schematically illustrating a seat control unit of the vehicle of the second embodiment;

FIG. 8 is a plan view schematically illustrating the vehicle of the second embodiment, and illustrates a state when the determination in the processing of step S22 shown in FIG. 10 of the seat control unit is affirmative;

FIG. 9 is a plan view schematically illustrating the vehicle of the second embodiment, and illustrates a state when the determination in the processing of step S24 shown in FIG. 10 of the seat control unit is affirmative;

FIG. 10 is a flowchart for explaining control by the seat control unit of the vehicle of the second embodiment;

FIG. 11 is a plan view schematically illustrating a vehicle of a third embodiment, and illustrates a state in which the seat at the front right side is oriented forward and the seat at the front left side is oriented rearward;

FIG. 12 is a plan view schematically illustrating the vehicle of the third embodiment, and illustrates a state in which the seat at the front right side and the seat at the front left side are oriented rearward;

FIG. 13 is a block diagram schematically illustrating a traveling control unit of a vehicle of a fourth embodiment;

FIG. 14 is a flowchart for explaining control by the traveling control unit of the vehicle of the fourth embodiment;

FIG. 15 is a plan view schematically illustrating a vehicle of a fifth embodiment;

FIG. 16 is a block diagram schematically illustrating the seat control unit of the vehicle of the fifth embodiment;

FIG. 17 is a plan view schematically illustrating the vehicle of the fifth embodiment, and illustrates a state in which a seat at a rear side of a cabin is positioned at the right side with respect to the position illustrated in FIG. 15; and

FIG. 18 is a flowchart for explaining control by the seat control unit of the vehicle of the fifth embodiment.

### DETAILED DESCRIPTION

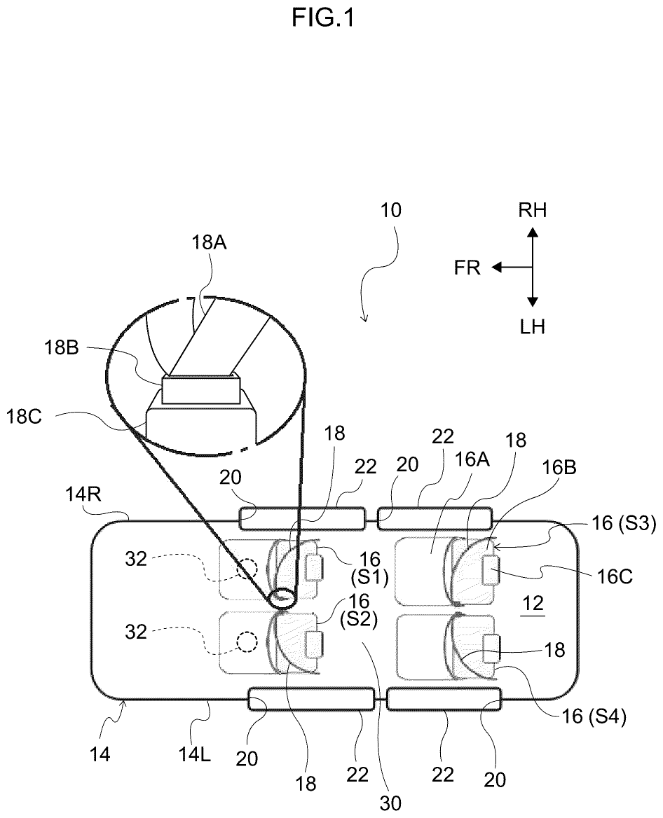

(Vehicle 10 of First Embodiment) A vehicle 10 relating to a first embodiment of the present disclosure is described by using FIG. 1 through FIG. 4. Note that arrow FR shown appropriately in the respective drawings indicates a front side in a vehicle front-rear direction, arrow UP indicates an upper side in a vehicle vertical direction, arrow RH indicates a right side in a vehicle transverse direction, and arrow LH indicates a left side in the vehicle transverse direction. Further, when description is given by merely using front-rear, left-right and vertical directions hereinafter, they refer to the front-rear of the vehicle front-rear direction, the left-right of the vehicle left-right direction (the vehicle transverse direction) and the vertical of the vehicle vertical direction, unless otherwise indicated.

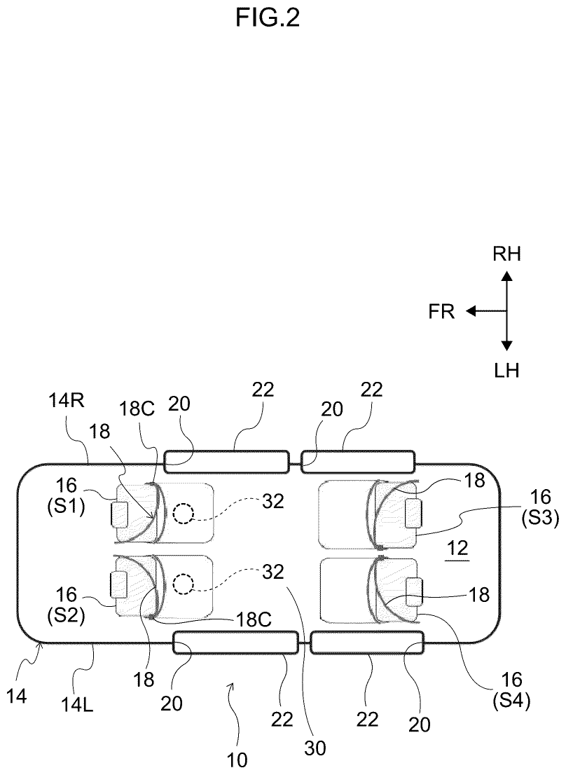

As illustrated in FIG. 1 and FIG. 2, the vehicle 10 of the present embodiment is an autonomous vehicle that can travel without being driven by a vehicle occupant. The vehicle 10 has: a vehicle body 14 having a cabin 12 in which passengers ride; four seats 16 provided within the cabin 12; and four seatbelt devices 18 provided at the four seats 16, respectively.

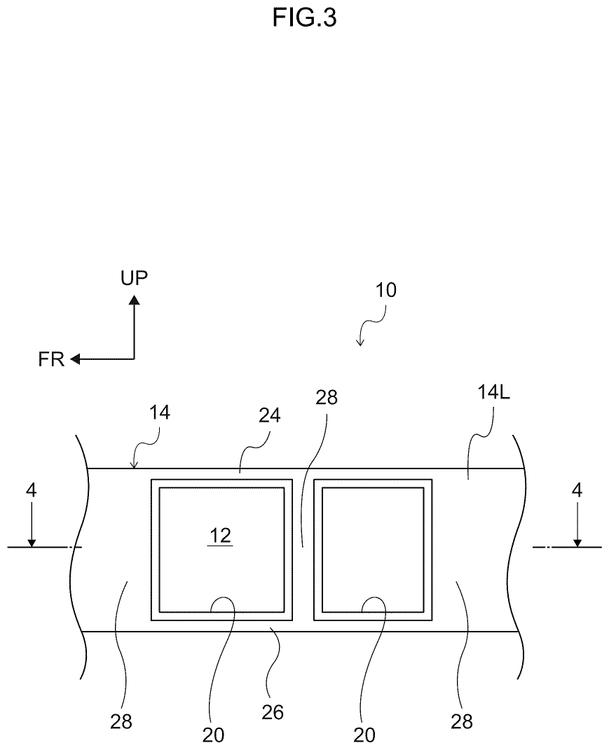

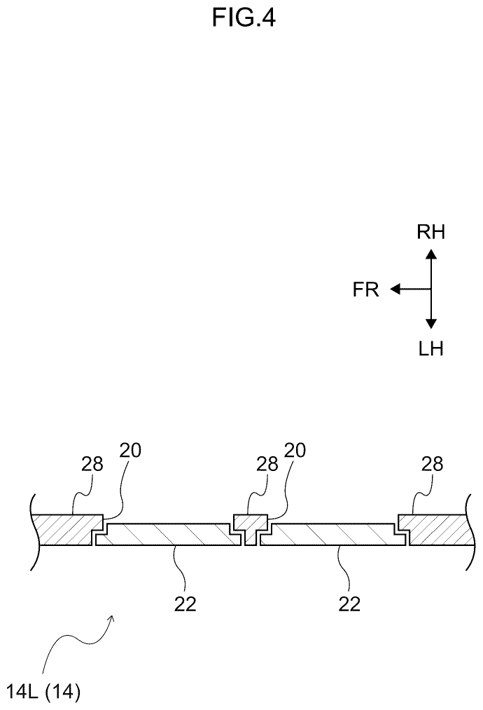

The vehicle body 14 is formed in the shape of a box at which the four seats 16 can be disposed within the cabin 12. Two side door opening portions 20 are formed at a side portion 14L at a left side of the vehicle body 14. Two of the side door opening portions 20 are formed at a side portion 14R at a right side of the vehicle body 14. These four side door opening portions 20 can be opened and closed by four side doors 22, respectively. As illustrated in FIG. 3 and FIG. 4, the side door opening portions 20 are substantially rectangular and are formed at the side portions 14L, 14R of the vehicle body 14 as seen in a side view of the vehicle body 14. The upper portions and lower portions of the side door opening portions 20 are respectively a roof side rail 24 and a rocker 26 that structure vehicle body frame portions of the vehicle body 14. Further, front portions and rear portions of the side door opening portions 20 are respectively pillars 28 that structure vehicle body frame portions of the vehicle body 14. The respective pillars 28 connect the roof side rail 24 and the rocker 26 in the vertical direction.

As illustrated in FIG. 1 and FIG. 2, the seat 16 has a seat cushion 16A that supports the buttocks of the seated passenger from the lower side, a seatback 16B that supports the back of the seated passenger from the seat rear side, and a headrest 16C that supports the head of the seated passenger from the seat rear side. Note that the seat front side, the seat rear side, the seat left side and the seat right side respectively indicate the seat front side, rear side, right side and left side as seen from the passenger seated in the seat 16. Further, the respective directions that are the seat left side and the seat right side coincide with the seat transverse direction.

In the present embodiment, two of the seats 16 are provided at the rear side of the cabin 12, and these two seats 16 are disposed so as to be lined-up in the left-right direction. Further, these two seats 16 are attached to a floor 30 of the cabin 12 in states of being oriented forward. Further, in the present embodiment, two of the seats 16 are provided at the front side of the cabin 12, and these two seats 16 are disposed so as to be lined-up in the left-right direction. Note that, when differentiating among the seat 16 at the front right side, the seat 16 at the front left side, the seat 16 at the rear right side and the seat 16 at the rear left side, S1 through S4 will be appended to the reference numeral of the seat 16. Namely, the respective seats 16 are designated as seat 16(S1) at the front right side, seat 16(S2) at the front left side, seat 16(S3) at the rear right side, and seat 16(S4) at the rear left side. Further, the two seats 16(S1, S2) at the front side of the cabin 12 are attached to the floor 30 of the cabin 12. A rotation supporting portion 32, which supports the seat 16(S1) such that the seat 16(S1) can rotate about an axis that is along the vertical direction, is provided between the seat 16(S1) and the floor 30. Due to this rotation supporting portion 32 being provided, the seat 16(S1) can be rotated between a state of being oriented forward and a state of being oriented rearward. Further, a locking mechanism that locks the rotation of the seat 16(S1) is provided at the rotation supporting portion 32. Due thereto, the respective states, which are the state in which the seat 16(S1) is oriented forward and the state in which the seat 16(S1) is oriented rearward, can be maintained. Note that another rotation supporting portion 32, which has a structure similar to that of the rotation supporting portion 32 provided between the seat 16(S1) and the floor 30, is provided also between the seat 16(S2), which is provided at the front left side of the cabin 12, and the floor 30.

The seatbelt device 18 of the present embodiment is a so-called three-point seatbelt device. The seatbelt device 18 has a seatbelt 18A formed in the shape of a belt, an unillustrated retractor on which the seatbelt 18A is taken-up, a tongue plate 18B through which the seatbelt 18A is inserted, and a buckle 18C with which the tongue plate 18B is engaged. One end portion of the seatbelt 18A is taken-up on the retractor that is fixed within the seatback 16B. Another end portion of the seatbelt 18A is fixed to one end in a seat transverse direction of the seat cushion 16A. At the seat 16(S1) at the front right side and the seat 16(S3) at the rear right side, the other end portion of the seatbelt 18A is fixed to a right side end portion in the seat transverse direction of the seat cushion 16A, and the buckle 18C is fixed to a left side end portion in the seat transverse direction of the seat cushion 16A. Further, at the seat 16(S2) at the front left side and the seat 16(S4) at the rear left side, the other end portion of the seatbelt 18A is fixed to a left side end portion in the seat transverse direction of the seat cushion 16A, and the buckle 18C is fixed to a right side end portion in the seat transverse direction of the seat cushion 16A.

As illustrated in FIG. 2, in the state in which the seat 16(S1) at the front right side is oriented rearward, the left side of this seat 16(S1) is disposed at the right side portion 14R of the vehicle body 14. In addition, the buckle 18C of this seat 16(S1) is disposed at a position that does not overlap, in the vehicle transverse direction, the side door opening portions 20 formed at the right side portion 14R of the vehicle body 14. Further, the buckle 18C is disposed at a position that overlaps the pillar 28 in the vehicle transverse direction.

Further, in the vehicle 10, in the state in which the seat 16(S2) at the front left side is oriented rearward, the right side of this seat 16(S2) is disposed at the left side portion 14L of the vehicle body 14. In addition, the buckle 18C of this seat 16(S2) is disposed at a position that does not overlap, in the vehicle transverse direction, the side door opening portions 20 formed at the left side portion 14L of the vehicle body 14. Further, the buckle 18C is disposed at a position that overlaps the pillar 28 in the vehicle transverse direction.

In the above-described vehicle 10, the seat 16(S1) at the front right side and the seat 16(S2) at the front left side can be oriented rearward. Further, due to the passengers seated in the seat 16(S1) and the seat 16(S2) engaging the tongue plates 18B with the buckles 18C, the seatbelts 18A are applied to the seated passengers. In the state in which the seat 16(S1) and the seat 16(S2) are oriented rearward, the locations where the buckles 18C are fixed at these seats 16(S1, S2) are disposed at the side portions 14L, 14R in the vehicle transverse direction of the vehicle body 14. Further, the buckles 18C and the side door opening portions 20 do not overlap in the vehicle transverse direction. Due thereto, even if the side doors 22 are displaced toward a cabin 12 side at the time of a side collision, the clearances between the side doors 22 and the seat 16(S1) at the front right side and the seat 16(S2) at the front left side are ensured. As a result, operation of the buckles 18C becoming difficult at the time of a side collision can be suppressed.

Further, in the state in which the seat 16(S1) at the front right side and the seat 16(S2) at the front left side are oriented rearward, the buckles 18C and the pillars 28, at which an amount of deformation toward the cabin 12 side at the time of a side collision is small, overlap one another in the vehicle transverse direction. Due thereto, at the time of a side collision, the clearances between the pillars 28 and the buckles 18C of the seat 16(S1) and the seat 16(S2) are ensured, and operation of the buckles 18C becoming difficult at the time of a side collision can be suppressed even more.

(Vehicle 34 of Second Embodiment)

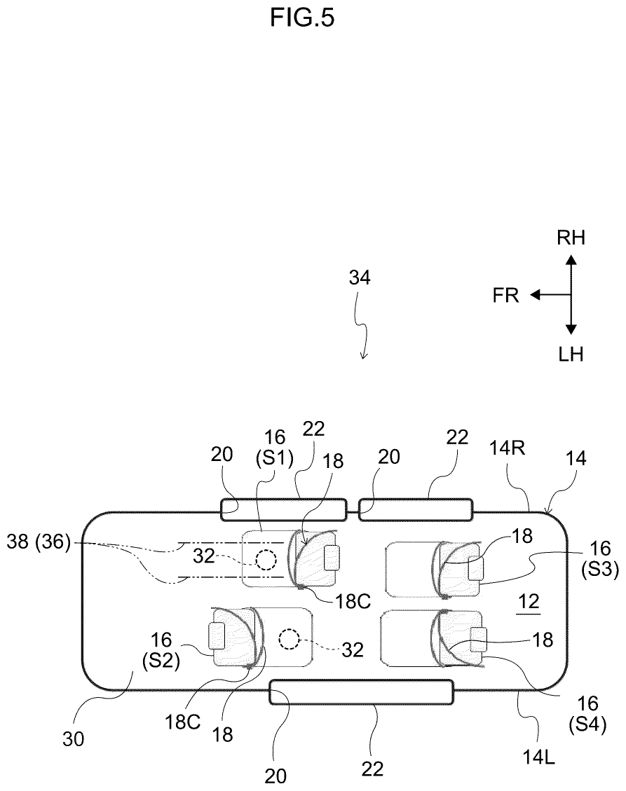

A vehicle 34 relating to a second embodiment of the present disclosure is described by using FIG. 5 through FIG. 10. Note that, at the vehicle 34 relating to the second embodiment, members and portions corresponding to those of the above-described vehicle 10 relating to the first embodiment are denoted by the same reference numerals as the corresponding members and portions of the vehicle 10, and description thereof may be omitted.

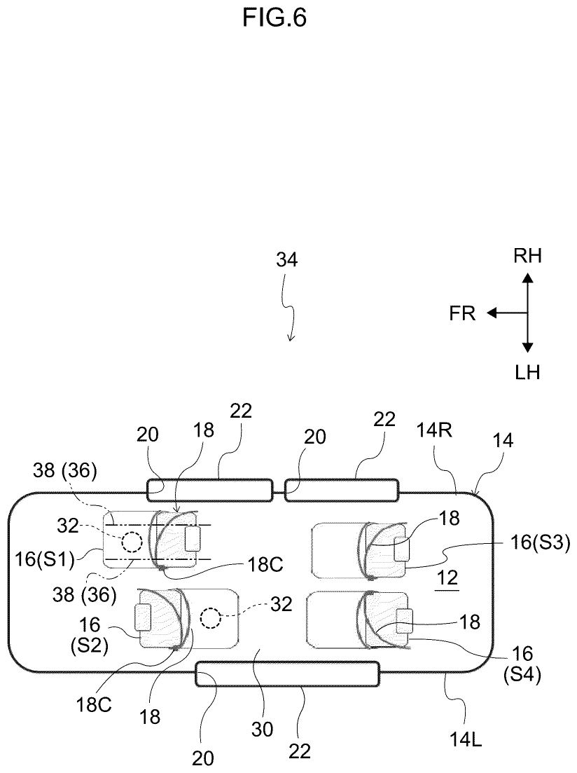

As illustrated in FIG. 5 and FIG. 6, the basic structure of the vehicle 34 of the present embodiment is similar to that of the vehicle 10 of the first embodiment, except for the point that the number of the side door opening portions 20 formed at the left side portion 14L of the vehicle body 14 is different, and except for the following points.

Specifically, a front-rear slide supporting portion 36, which supports the seat 16(S1) such that the seat 16(S1) can move in the front-rear direction, is provided between the floor 30 of the cabin 12 and the seat 16(S1) that is provided at the front right side. The front-rear slide supporting portion 36 is structured to include lower rails 38 fixed to the floor 30, and upper rails fixed to a lower portion of the seat 16(S1). Due to the upper rails moving along the lower rails 38, the seat 16(S1) moves in the front-rear direction. Note that, although not illustrated, another front-rear slide supporting portion 36, which has a structure similar to that of the front-rear slide supporting portion 36 provided between the floor 30 and the seat 16(S1), is provided also between the floor 30 and the seat 16(S2) provided at the front left side.

As illustrated in FIG. 5 through FIG. 7, a front-rear sliding actuator 40, which, by operating, moves the seat 16(S1) in the front-rear direction, is provided at the seat 16(S1) that is provided at the front right side. Note that the front-rear sliding actuator 40 is provided also at the seat 16(S2) at the front left side. These front-rear sliding actuators 40 are controlled by a seat control unit 42. Further, sensors, which can detect positions of the seats 16(S1, S2) in the front-rear direction, are provided at these front-rear sliding actuators 40.

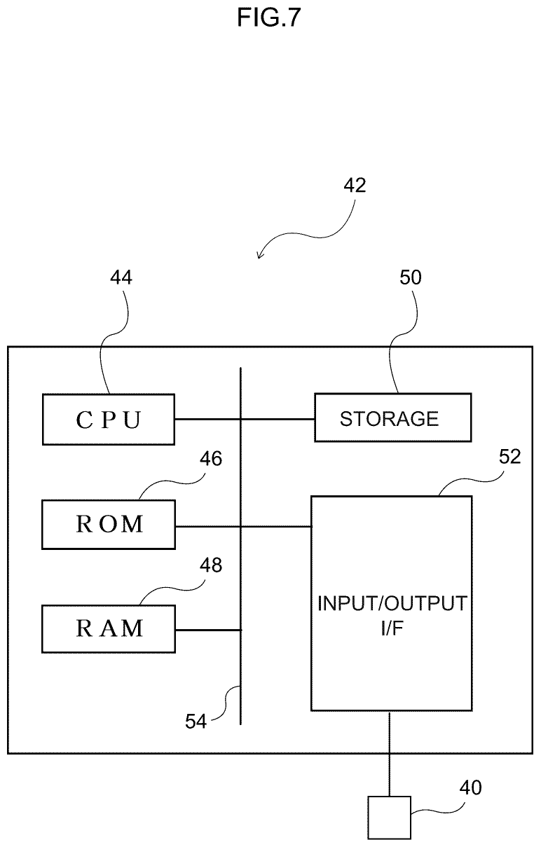

As illustrated in FIG. 7, as an example, the seat control unit 42 has a CPU (Central Processing Unit: processor) 44, a ROM (Read Only Memory) 46, a RAM (Random Access Memory) 48, a storage 50, and an input/output interface (UF) 52 that carries out communications with external devices. The seat control unit 42 is structured such that these are connected so as to be able to communicate with one another via bus 54.

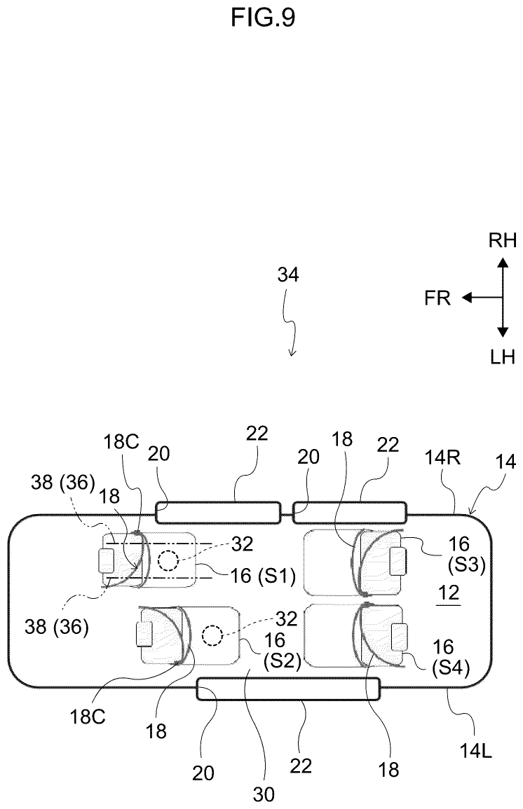

The front-rear sliding actuators 40 are electrically connected to the input/output interface 52. The CPU 44 is a central computing processing unit, and executes various programs, and controls the operations of the front-rear sliding actuators 40. In detail, on the basis of signals from the sensors provided at the front-rear sliding actuators 40, or the like, the CPU 44 reads-out a control program from the ROM 46 or the storage 50, and executes the control program by using the RAM 48 as a workspace, and controls the operations of the front-rear sliding actuators 40. Due thereto, as illustrated in FIG. 9, the seats 16(S1, S2) move automatically to positions at which the buckles 18C and the side door opening portions 20 do not overlap in the vehicle transverse direction.

Control, by the seat control unit 42, of the front-rear sliding actuator 40 provided at the seat 16(S1) at the front right side is described hereinafter.

In a traveling standby state in which the vehicle 34 can travel or in a traveling state in which the vehicle 34 is traveling, the seat control unit 42 controls the front-rear sliding actuator 40 in accordance with the following control flow. Note that, in a parked state of the vehicle 34, the seat control unit 42 does not carry out control of the front-rear sliding actuator 40 in accordance with the following control flow.

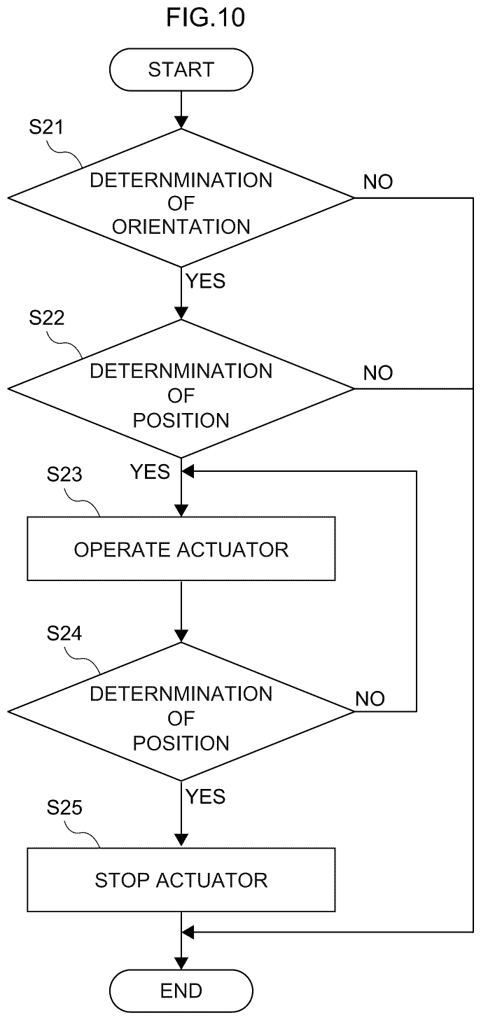

As illustrated in FIG. 5 and FIG. 10, in the traveling standby state or in the traveling state, first, in step S21 shown in FIG. 10, the seat control unit 42 determines whether or not the seat 16(S1) at the front right side is oriented rearward. If the determination in step S21 is negative, the seat control unit 42 ends processing and repeats the processing of step S21.

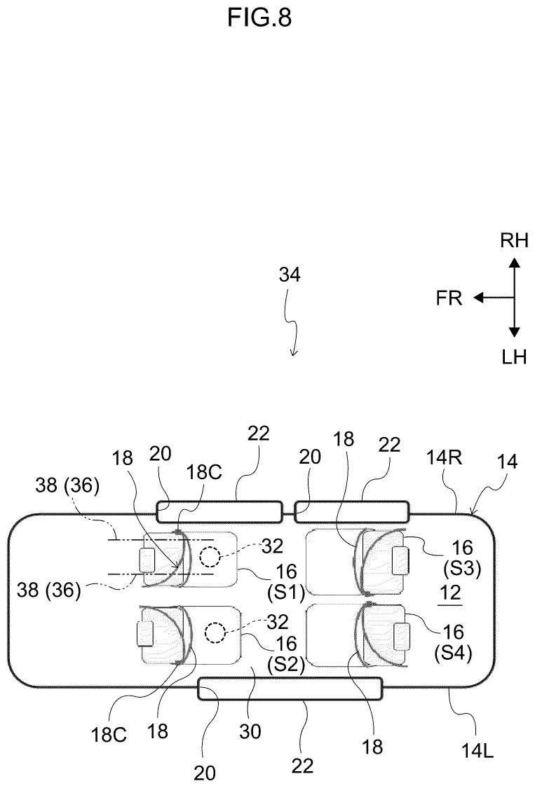

As illustrated in FIG. 8 and FIG. 10, if the determination in step S21 is affirmative, in step S22, the seat control unit 42 determines whether or not the seat 16(S1) is disposed at a position at which the buckle 18C of the seat 16(S1) and the side door opening portion 20 at the right side portion 14R of the vehicle body 14 overlap in the vehicle transverse direction. If the determination in step S22 is negative, the seat control unit 42 ends processing, and repeats the processing from step S21 on.

In contrast, if the determination in step S22 is affirmative, in step S23, the seat control unit 42 operates the front-rear sliding actuator 40 and moves the seat 16(S1) forward.

Next, in step S24, the seat control unit 42 determines whether or not the seat 16(S1) is positioned at a prescribed position. Here, the prescribed position in step S24 is a position of the seat 16(S1) in a state in which the buckle 18C of the seat 16(S1) is disposed at a position that does not overlap the side door opening portion 20 of the right side portion 14R of the vehicle body 14 in the vehicle transverse direction, and is disposed at a position overlapping the pillar 28 in the vehicle transverse direction. If the determination in step S24 is negative, the seat control unit 42 repeats the processing from step S23 on.

In contrast, as illustrated in FIG. 9 and FIG. 10, if the determination in step S24 is affirmative, in step S25, the seat control unit 42 terminates the operation of the front-rear sliding actuator 40, and ends processing.

In the above-described vehicle 34 of the present embodiment as well, even if the side door 22 is displaced toward the cabin 12 side at the time of a side collision, the clearance between the side door 22 and the buckle 18C of the seat 16(S1) at the front right side is ensured. As a result, operation of the buckle 18C becoming difficult at the time of a side collision can be suppressed.

(Vehicle 56 of Third Embodiment)

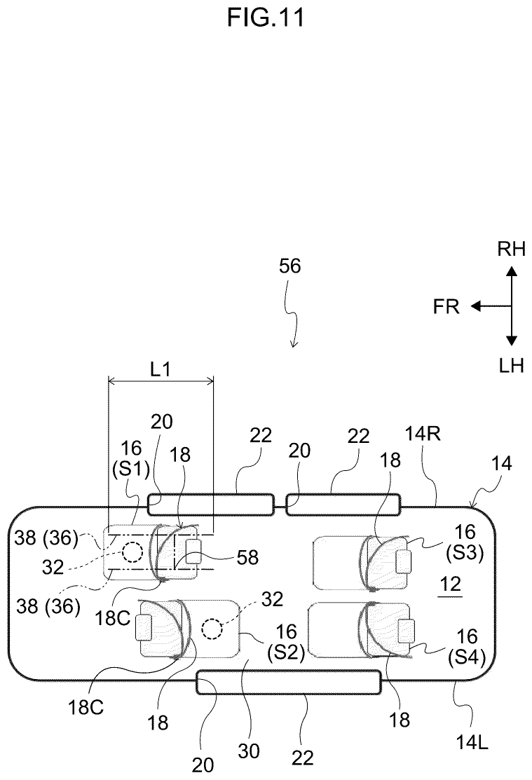

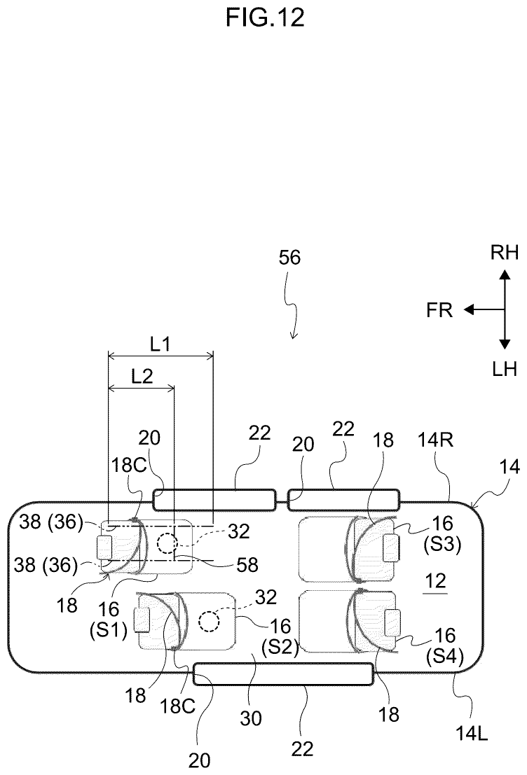

A vehicle 56 relating to a third embodiment of the present disclosure is described by using FIG. 11 and FIG. 12. Note that, at the vehicle 56, members and portions corresponding to those of the above-described vehicle 10 relating to the first embodiment and the like, are denoted by the same reference numerals as the corresponding members and portions of the vehicles 10, 34, and description thereof may be omitted.

As illustrated in FIG. 11 and FIG. 12, the basic structure of the vehicle 56 of the present embodiment is a structure that is similar to that of the vehicle 34 of the second embodiment, except for the point that the passengers can manually move the seat 16(S1) at the front right side and the seat 16(S2) at the front left side in the front-rear direction.

Limiting portions 58, which limit the ranges of movement in the front-rear direction of the seats 16(S1, S2) in states in which the seats 16(S1, S2) are oriented rearward, are provided at the front-rear slide supporting portions 36 of the present embodiment. Hereinafter, operation of the limiting portion 58 at the time when the seat 16(S1) at the front right side is moved in the front-rear direction is described.

As illustrated in FIG. 11, in the state in which the seat 16(S1) is oriented forward, the limiting portion 58 does not operate. Therefore, in the state in which the seat 16(S1) is oriented forward, the seat 16(S1) can be moved in the front-rear direction in an entire range L1 that is permitted by the front-rear slide supporting portion 36.

On the other hand, as illustrated in FIG. 12, in the state in which the seat 16(S1) is oriented rearward, the limiting portion 58 operates. Due thereto, in the state in which the seat 16(S1) is oriented rearward, the seat 16(S1) can be moved in the front-rear direction within a range L2 at which the buckle 18C and the side door opening portion 20 do not overlap in the vehicle transverse direction, of the range L1 that is permitted by the front-rear slide supporting portion 36. Note that, in the present embodiment, in a state in which the seat 16(S1) is positioned outside of the above-described range L2, the seat 16(S1) cannot be oriented rearward. Due thereto, in the vehicle 56 of the present embodiment as well, even if the side door 22 is displaced toward the cabin 12 side at the time of a side collision, the clearance between the side door 22 and the buckle 18C of the seat 16(S1) at the front right side is ensured. As a result, operation of the buckle 18C becoming difficult at the time of a side collision can be suppressed.

Note that, in the vehicle 56, in the state in which the seat 16(S1) at the front right side is oriented rearward, the seat 16(S1) can be moved in the front-rear direction within the range L2 at which the buckle 18C and the side door opening portion 20 do not overlap in the vehicle transverse direction, of the range L1 that is permitted by the front-rear slide supporting portion 36. However, the present disclosure is not limited to this. For example, it may be made such that, in the state in which the seat 16(S1) is oriented rearward, the seat 16(S1) cannot be moved in the front-rear direction due to operation of the limiting portion 58.

(Vehicle of Fourth Embodiment)

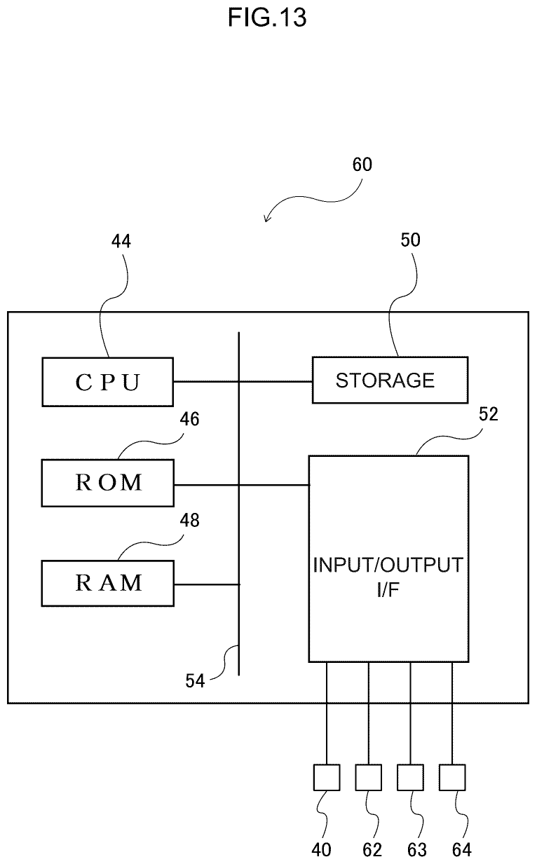

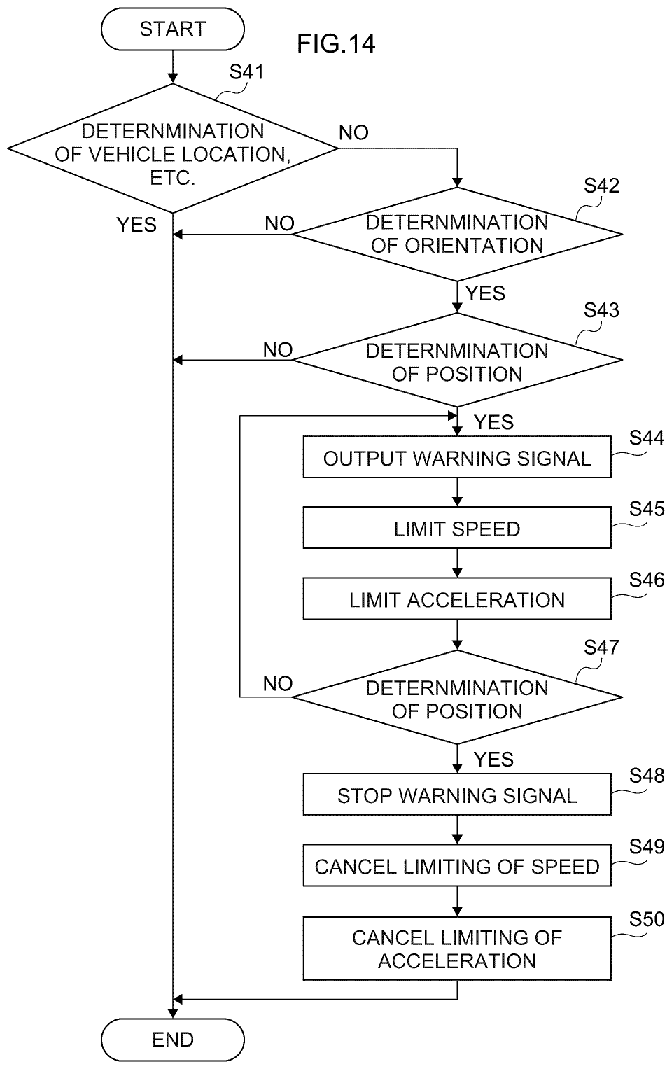

A vehicle relating to a fourth embodiment of the present disclosure is described by using FIG. 13 and FIG. 14. Note that, at the vehicle relating to the fourth embodiment, members and portions corresponding to those of the above-described vehicle 10 relating to the first embodiment and the like are denoted by the same reference numerals as the corresponding members and portions of the previously-described vehicle 10, and description thereof may be omitted.

A block diagram of a traveling control unit 60, which structures a portion of the vehicle of the fourth embodiment, is illustrated in FIG. 13. Note that the basic structure of the traveling control unit 60 is structured similarly to that of the above-described seat control unit 42. Therefore, the respective elements that structure the traveling control unit 60 are denoted by the reference numerals of the corresponding elements that structure the seat control unit 42. Further, the structure of the vehicle of the fourth embodiment is a structure similar to that of the above-described vehicle 34 of the second embodiment, except that the following control is carried out by the traveling control unit 60.

As illustrated in FIG. 13, the front-rear sliding actuators 40 are electrically connected to the input/output interface 52 of the traveling control unit 60. Further, a power unit 62, which is the power source of the vehicle, and a warning light 63, which is provided in the cabin 12, are electrically connected to the input/output interface 52 of the traveling control unit 60. Moreover, a road information acquiring unit 64, in which information of the road on which the vehicle is traveling is stored, is electrically connected to the input/output interface 52 of the traveling control unit 60. Further, on the basis of signals from the sensors provided at the front-rear sliding actuators 40 and signals from the road information acquiring unit 64, or the like, the CPU 44 of the traveling control unit 60 reads-out a control program from the ROM 46 or the storage 50, and executes the control program by using the RAM 48 as a workspace, and controls the traveling and the like of the vehicle.

Control by the traveling control unit 60 in relation to the seat 16(S1) at the front right side is described hereinafter in the same way as the description in the second embodiment.

In a traveling standby state in which the vehicle can travel or in a traveling state in which the vehicle is traveling, the traveling control unit 60 controls the traveling and the like of the vehicle in accordance with the following control flow. Note that, in a parked state, the traveling control unit 60 does not carry out control of traveling and the like of the vehicle in accordance with the following control flow.

As illustrated in FIG. 13 and FIG. 14, in the traveling standby state or in the traveling state, first, in step S41, the traveling control unit 60 determines, on the basis of signals from the road information acquiring unit 64 and the like, whether or not there is at least one case among a case in which the vehicle is located on a road on which only autonomous vehicles can travel, and a case in which the speed limit of the road on which the vehicle is located is less than or equal to a prescribed speed. If the determination in step S41 is affirmative, the traveling control unit 60 ends processing and repeats the processing of step S41. Note that the prescribed speed in step S41 is a speed at which it is predicted that, even if the vehicle were to be involved in a collision, there would be no displacement or there would be a small amount of displacement of the side doors 22 toward the cabin 12 side, and, as an example, is a speed of around 30 km/h.

If the determination in step S41 is negative, in step S42, the traveling control unit 60 determines whether or not the seat 16(S1) at the front right side is oriented rearward. If the determination in step S42 is negative, the traveling control unit 60 ends processing, and repeats processing from step S41 on.

If the determination in step S42 is affirmative, in step S43, the traveling control unit 60 determines whether or not the seat 16(S1) at the front right side is disposed at a position at which the buckle 18C of that seat 16(S1) and the side door opening portion 20 formed at the right side portion 14R of the vehicle body 14 overlap in the vehicle transverse direction. If the determination in step S43 is negative, the traveling control unit 60 ends processing, and repeats the processing from step S41 on.

If the determination in step S43 is affirmative, the traveling control unit 60 outputs a warning signal in step S44, and limits the speed of the vehicle in step S45, and limits the acceleration of the vehicle in step S46.

Next, in step S47, the traveling control unit 60 determines whether or not the seat 16(S1) at the front right side is disposed at a position at which the buckle 18C of that seat 16(S1) and the side door opening portion 20 formed in the right side portion 14R of the vehicle body 14 do not overlap in the vehicle transverse direction. If the determination in step S47 is negative, the traveling control unit 60 repeats the processing from step S44 on.

If the determination in step S47 is affirmative, the traveling control unit 60 terminates output of the warning signal in step S48, and cancels the limiting of the speed of the vehicle in step S49, and cancels the limiting of the acceleration of the vehicle in step S50, and ends processing.

As described above, in the vehicle of the present embodiment, in a state in which the seat 16(S1) at the front right side is oriented toward the vehicle rear side, when it is detected by the traveling control unit 60 that the seat 16(S1) is disposed at a position at which the buckle 18C and the side door opening portion 20 overlap in the vehicle transverse direction, the traveling control unit 60 carries out outputting of a warning signal. Due to the warning light 63 being lit on the basis of this warning signal, the passenger can be urged to move the seat 16(S1) to a position at which the buckle 18C and the side door opening portion 20 do not overlap in the vehicle transverse direction. Further, the passenger can be urged to move the seat 16(S1) to a position at which the buckle 18C and the side door opening portion 20 do not overlap in the vehicle transverse direction, also due to the traveling control unit 60 limiting the traveling speed of the vehicle or limiting the acceleration of the vehicle.

Further, in the vehicle of the present embodiment, the traveling control unit 60 does not carry out the processing of steps S44, S45, S46 in a case in which the vehicle is located on a road on which only autonomous vehicles can travel, or in which the speed limit of the road on which the vehicle is located is less than or equal to a prescribed speed. Namely, in a situation in which it is anticipated that there will be a small amount of displacement of the side door 22 toward the cabin 12 side even if the vehicle is involved in a side collision, the traveling control unit 60 does not carry out the processing of steps S44, S45, S46. Due thereto, the seat 16(S1) being disposed at a position at which the buckle 18C and the side door opening portion 20 overlap in the vehicle transverse direction can be permitted. Further, even if the vehicle is involved in a side collision in this situation, the clearance between the side door 22 and the buckle 18C is ensured, and operation of the buckle 18C becoming difficult at the time of the side collision can be suppressed.

Note that the present embodiment describes an example in which the processing of step S41 is carried out, but the present disclosure is not limited to this. For example, only the processing from step S42 on may be carried out, without carrying out the processing of step S41. Further, although the present embodiment describes an example in which the processing of steps S44, S45, S46 are carried out, the present disclosure is not limited to this. For example, it is possible to carry out any one of the processing of steps S44, S45, S46, or to carry out any two processing among steps S44, S45, S46.

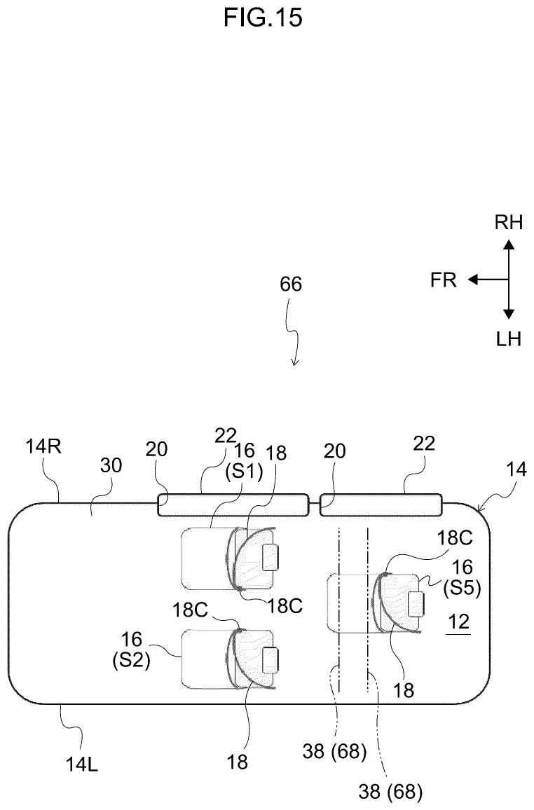

(Vehicle 66 of Fifth Embodiment) A vehicle 66 relating to a fifth embodiment of the present disclosure is described by using FIG. 15 through FIG. 18. Note that, at the vehicle 66 relating to the fifth embodiment, members and portions corresponding to those of the above-described vehicle 10 relating to the first embodiment and the like are denoted by the same reference numerals as the corresponding members and portions of the vehicle 10 and the like, and description thereof may be omitted.

As illustrated in FIG. 15, in the vehicle 66 of the present embodiment, one seat 16 is provided at the rear side of the cabin 12. The seat 16 provided at the rear side of the cabin 12 is attached to the floor 30 of the cabin 12 in a state of being oriented forward. Note that, when differentiating this seat 16 from the other seats 16, S5 is appended to the reference numeral of the seat 16 provided at the rear side of the cabin 12 such that it is called seat 16(S5).

At the seat 16(S5), the end portion at the other side of the seatbelt 18A is fixed to an end portion in a transverse direction of the seat cushion 16A, and the buckle 18C is fixed to a right side end portion in the transverse direction of the seat cushion 16A.

Further, a left-right slide supporting portion 68, which supports the seat 16(S5) such that the seat 16(S5) can move in the vehicle transverse direction, is provided between the seat 16(S5) and the floor 30. The left-right slide supporting portion 68 is structured to include the lower rails 38 that are fixed to the floor 30, and upper rails that are fixed to the lower portion of the seat 16(S5). The seat 16(S5) moves in the vehicle transverse direction due to the upper rails moving along the lower rails 38.

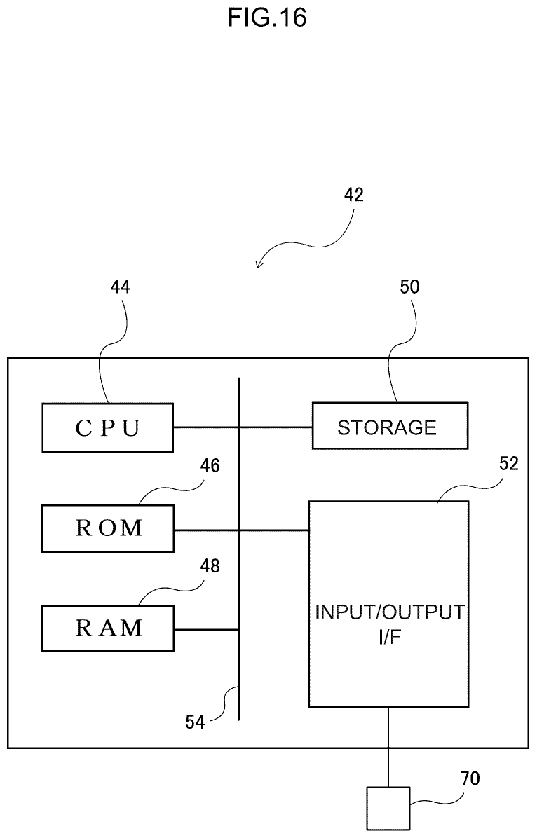

As illustrated in FIG. 15 and FIG. 16, a left-right sliding actuator 70, which, by operating, moves the seat 16(S5) in the vehicle transverse direction, is provided at the seat 16(S5). This left-right sliding actuator 70 is controlled by the seat control unit 42. A sensor that can detect a position in the vehicle transverse direction of the seat 16(S5) is provided at the left-right sliding actuator 70.

A block diagram of the seat control unit 42 of the vehicle 66 of the fifth embodiment is shown in FIG. 16. The structure of the seat control unit 42 is similar to that of the seat control unit 42 of the vehicle 34 of the second embodiment.

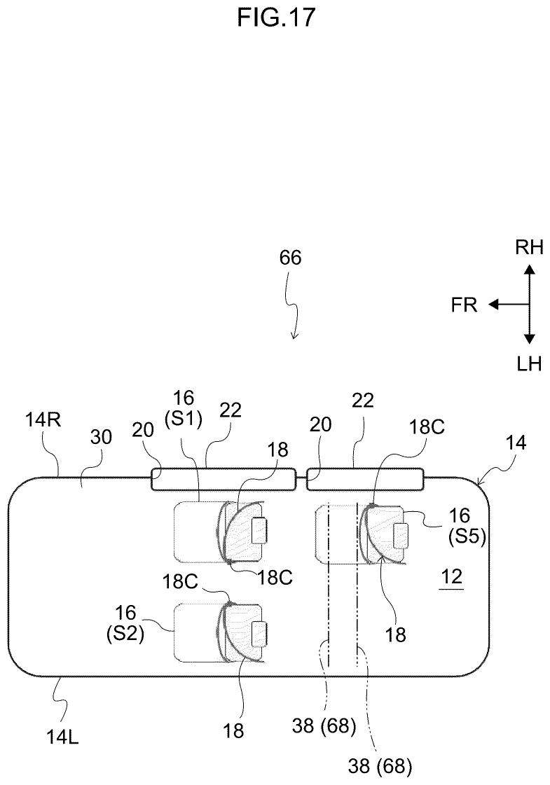

The left-right sliding actuator 70 is electrically connected to the input/output interface 52 of the seat control unit 42 of the vehicle 66. On the basis of a signal from the sensor provided at the left-right sliding actuator 70, or the like, the CPU 44 reads-out a control program from the ROM 46 or the storage 50, and executes the control program by using the RAM 48 as a workspace, and controls the operation of the left-right sliding actuator 70. Due thereto, as illustrated in FIG. 15 and FIG. 17, the seat 16(S5) is automatically moved to a position at which the interval between the buckle 18C and the side door 22 becomes a prescribed interval or greater.

Control, by the seat control unit 42, of the left-right sliding actuator 70 provided at the seat 16(S5) is described hereinafter.

In a traveling standby state in which the vehicle 66 can travel or in a traveling state in which the vehicle 66 is traveling, the seat control unit 42 controls the left-right sliding actuator 70 in accordance with the following control flow. Note that, in a parked state of the vehicle 66, the seat control unit 42 does not carry out control of the left-right sliding actuator 70 in accordance with the following control flow.

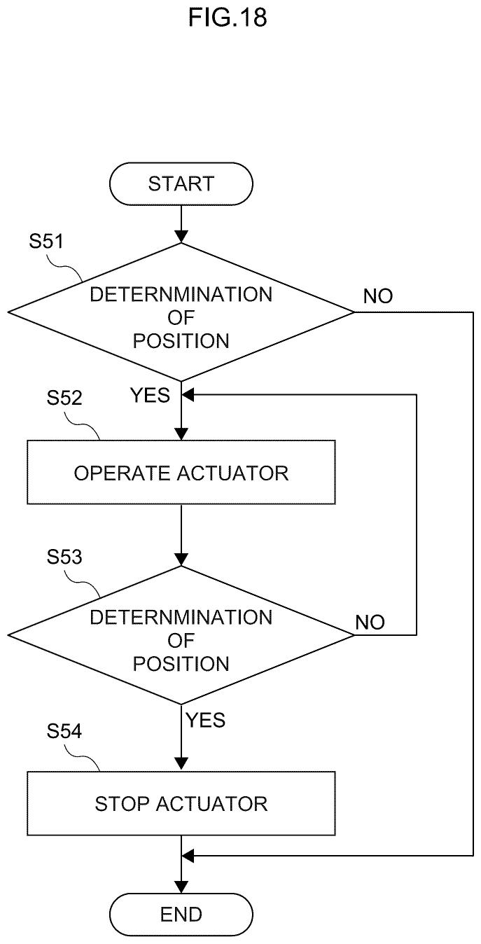

As illustrated in FIG. 15, FIG. 16 and FIG. 18, in the traveling standby state or in the traveling state, first, in step S51, the seat control unit 42 determines whether or not the interval between the buckle 18C, which is fixed to the seat 16(S5) at the rear side of the cabin 12, and the side door 22 is less than a prescribed interval. Note that the prescribed interval in step S51 is an interval between the buckle 18C and the side door 22 at which it is confirmed that, even if the side door 22 is displaced toward the cabin 12 side in accordance with a collision of the vehicle, the operation of the buckle 18C fixed to the seat 16(S5) will not be impeded. This interval is, as an example, around 30 cm. If the determination in step S51 is negative, the seat control unit 42 ends processing, and repeats the processing of step S51.

As illustrated in FIG. 16, FIG. 17 and FIG. 18, if the determination in step S51 is affirmative, in step S52, the seat control unit 42 operates the left-right sliding actuator 70, and moves the seat 16(S5) toward the left side.

Next, in step S53, the seat control unit 42 determines whether or not the interval between the buckle 18C of the seat 16(S5) and the side door 22 is greater than or equal to the prescribed interval. If the determination in step S53 is negative, the seat control unit 42 repeats processing from step S52 on.

In contrast, as illustrated in FIG. 15, FIG. 16 and FIG. 18, if the determination in step S53 is affirmative, in step S54, the seat control unit 42 terminates the operation of the left-right sliding actuator 70, and ends processing.

In the above-described vehicle 34 of the present embodiment as well, even if the side door 22 is displaced toward the cabin 12 side at the time of a side collision, the clearance between the side door 22 and the buckle 18C of the seat 16(S5) that is at the rear side of the cabin 12 is ensured. As a result, operation of the buckle 18C becoming difficult at the time of a side collision can be suppressed.

Note that the technical concepts of the respective disclosures of the above-described first through fifth embodiments can be combined with one another.

Although embodiments of the present disclosure have been described above, the present disclosure is not limited to the above, and, of course, can be implemented by being modified in various ways other than the above within a scope of the present disclosure.

What is claimed is:

1. A vehicle, comprising:
a vehicle body having a cabin in which a passenger rides, and a side door opening portion, which is opened and closed by a side door, formed at a side in a transverse direction of the vehicle body;
a seatbelt device having a seatbelt formed in a belt-shape, a tongue plate through which the seatbelt is inserted, and a buckle with which the tongue plate engages; and
a seat at which the seatbelt device is installed, the buckle being fixed at one side in a transverse direction of the seat, the seat being attached to a floor of the cabin so as to be rotatable about a rotation axis that extends in a vehicle vertical direction, and the seat being disposed at a position at which, in a state in which the seat is oriented toward a vehicle rear side, the one side in the transverse direction of the seat is disposed at the side in the transverse direction of the vehicle body, and the buckle and the side door opening portion do not overlap in a vehicle transverse direction.

2. The vehicle of claim 1, wherein the seat is attached to the floor of the cabin in a state in which movement of the seat in a vehicle front-rear direction with respect to the floor of the cabin is prohibited.

3. The vehicle of claim 1, further comprising:
a front-rear slide supporting portion that supports the seat such that the seat is movable in a vehicle front-rear direction;
a front-rear sliding actuator that, by operation, moves the seat in the vehicle front-rear direction; and
a seat control unit configured to control the front-rear sliding actuator,
wherein, the seat control unit comprises a memory and a processor coupled to the memory, the processor being configured to, when the processor detects that the seat is oriented toward the vehicle rear side, operate the front-rear sliding actuator such that the seat is moved to a position at which the buckle and the side door opening portion do not overlap in the vehicle transverse direction.

4. The vehicle of claim 1, further comprising a front-rear slide supporting portion that supports the seat such that the seat is movable in a vehicle front-rear direction,
wherein, in a state in which the seat is oriented toward the vehicle rear side, a range of movement of the seat that is permitted by the front-rear slide supporting portion is limited to a range within which the buckle and the side door opening portion do not overlap in the vehicle transverse direction.

5. The vehicle of claim 1, further comprising a front-rear slide supporting portion that supports the seat such that the seat is movable in a vehicle front-rear direction, wherein:
in a state in which the seat is oriented toward a vehicle front side, the seat is movable by the front-rear slide supporting portion, and
in a state in which the seat is oriented toward the vehicle rear side, the seat is not movable by the front-rear slide supporting portion.

6. The vehicle of claim 1, wherein, in a state in which the seat is oriented toward the vehicle rear side, the seat is disposed at a position at which the buckle and a vehicle body frame portion, which structures a frame at a side in the transverse direction of the vehicle body, overlap in the vehicle transverse direction.

7. A vehicle, comprising:
a vehicle body having a cabin in which a passenger rides, and a side door opening portion, which is opened and closed by a side door, formed at a side in a transverse direction of the vehicle body;
a seatbelt device having a seatbelt formed in a belt-shape, a tongue plate through which the seatbelt is inserted, and a buckle with which the tongue plate engages; and
a seat at which the seatbelt device is installed, the buckle being fixed at one side in a transverse direction of the seat, the seat being attached to a floor of the cabin so as to be rotatable about a rotation axis that extends in a vehicle vertical direction, and the seat being disposed at a position at which, in a state in which the seat is oriented toward a vehicle rear side, the one side in the transverse direction of the seat is disposed at the side in the transverse direction of the vehicle body, and the buckle and the side door opening portion do not overlap in a vehicle transverse direction; and
a traveling control unit configured to control traveling of the vehicle,
wherein, the traveling control unit comprises a memory and a processor coupled to the memory and, in a state in which the seat is oriented toward the vehicle rear side, in a case in which the processor detects that the seat is disposed at a position at which the buckle and the side door opening portion overlap in the vehicle transverse direction, the processor is configured to carry out at least one of outputting a warning signal, limiting a traveling speed of the vehicle, and limiting acceleration of the vehicle.

8. The vehicle of claim 7, wherein, in a case in which the vehicle is located on a road on which only autonomous vehicles can travel, or in a case in which a speed limit of a road on which the vehicle is located is less than or equal to a prescribed speed, the processor is configured to terminate control for the at least one of outputting the warning signal, limiting the traveling speed of the vehicle, and limiting the acceleration of the vehicle.

9. A vehicle, comprising:
a vehicle body having a cabin in which a passenger rides, and a side door opening portion, which is opened and closed by a side door, formed at a side in a transverse direction of the vehicle body;
a seatbelt device having a seatbelt formed in a belt-shape, a tongue plate through which the seatbelt is inserted, and a buckle with which the tongue plate engages;
a seat at which the seatbelt device is installed, the buckle being fixed at one side in a transverse direction of the seat, the seat being attached to a floor of the cabin so as to be rotatable about a rotation axis that extends in a vehicle vertical direction;
a left-right slide supporting portion that supports the seat such that the seat is movable in a vehicle transverse direction;
a left-right sliding actuator that, by operation, moves the seat in the vehicle transverse direction; and
a seat control unit configured to control the left-right sliding actuator,
wherein, the seat control unit comprises a memory and a processor coupled to the memory and, in a case in which the processor detects that an interval between the buckle and the side door is less than a prescribed interval, the processor is configured to operate the left-right sliding actuator such that the seat is moved to a position at which the interval between the buckle and the side door is greater than or equal to the prescribed interval.
